(19) United States
(12) Patent Application Publication
(10) Pub. No.: US 2026/0114457 A1
(43) Pub. Date: Apr. 30, 2026

(54) Baking Mold Device and Method

(71) Applicant: William Hess, San Diego, CA (US)

(72) Inventor: William Hess, San Diego, CA (US)

(21) Appl. No.: 19/373,616

(22) Filed: Oct. 29, 2025

Related U.S. Application Data
(60) Provisional application No. 63/713,141, filed on Oct. 29, 2024.

(51) Int. Cl. A21B 3/13

(52) U.S. Cl. CPC A21B 3/132

(57) ABSTRACT

A mold is provided for forming cookies and cakes into a cup-like shape. The mold has a base mold having an interior cavity which is positioned to surround dough on a support surface; An insert is positionable within the interior cavity to an inserted position. The insert in the inserted position forms a cup-like area of the interior cavity forming the dough to that shape for baking to provide a baked good, such as a cookie or cake with a cup-like shape.

This application claims priority to U.S. Provisional patent application Ser. No. 63/713,141 filed on Oct. 29, 2024. The present device relates to baking. More particularly, the disclosed device relates to a mold for forming shaped bake goods which is employable singularly or in a group thereof to significantly increase production capability during baking.

### BACKGROUND OF THE INVENTION

### Field of the Invention

Baking using a mold, such as cake molds, provide a useful tool for those baking cakes and the like. Rather than depending upon the liquid ingredients to maintain a form during baking, which is a less than reliable method, such molds are configured to hold the ingredients and give the resulting cake or the like a predictable shape. Different types of baking molds are available, including silicone, aluminum, and steel, and each has its own advantages as well as disadvantages.

Molds configured of silicone or other heat resistant polymeric material are flexible and are provided in a variety of shapes and sizes. Formed of material, such as silicone, they provide a mold from which baked goods may be removed once cooked, without sticking. Such molds can also give cakes and other molded baked goods a professional look with clean lines and detailed imprints.

However, flexible polymeric molds have their disadvantages. For example, flexible molds, such as silicone molds, can be tricky when used, since being flexible, they are hard to position within and then remove from the oven when filled with a liquid mix.

There are other molds commercially available for baking, such as silicone coated metal, as well as conventional metal molds, such as those employed for bundt cakes and the like. While substantially rigid in construction, these molds can cause problems with the sticking of the baked goods thereto. Further, in a similar fashion to silicone molds, they are configured for individual use for the cake being formed.

The foregoing background concerning the conventional manner for cooking baked food items and the limitations related therewith are intended to be illustrative and not exclusive, and they do not imply any limitations on the invention described and claimed herein. Various other limitations of the related art of baking molds and their employment are known or will become apparent to those skilled in the art upon a reading and understanding of the specification below and the accompanying drawings.

### SUMMARY OF THE INVENTION

The device herein provides a mold for the easy formation and baking of shaped bake goods, such as cakes and cookies. For example, and in no way to be considered limiting, in one mode of the device and system herein, cookie dough placed in the mold and baking may yield a cookie or cake in the shape of a shot glass or cup with a cavity formed therein especially well configured for placement of other confectionary material therein, such as frosting or pudding or the like.

The device and system herein provide for scalability to use multiple similarly configured baking molds concurrently, to significantly increase the ability to form multiple substantially identical cookies or cakes using multiple mold devices concurrently situated in an oven.

The device features a base mold having an interior cavity defined by the shape and height of a surrounding sidewall of the base mold. The base mold is open at both ends, and it is configured for operative positioning upon a baking sheet prior to and during use in an oven. The interior of the sidewall of the base mold surrounding the interior cavity of the base mold may be coated with non-stick material, such as Teflon or silicone.

In use, the base mold is positioned upon a cookie baking sheet or silicone baking sheet, or other support surface, which will hold one or a plurality of the base molds thereon. So positioned on a support surface, a portion of uncooked dough material is deposited through the upper open end at the top of the sidewall opposite the lower open end on the end of the base mold, which is placed on the support surface, such as a cookie sheet.

With the cookie dough positioned at a bottom end of the base mold and upon the support surface, an insert is slid into the interior cavity. The insert has a length extending from a first end to a second end thereof, which is shorter than a length of the sidewall surrounding the interior cavity.

The insert has a first portion thereof having an exterior circumferential surface which is shaped substantially the same as the interior surface of the sidewall of the base mold, which defines a shape of the interior cavity. During the translation of the insert through one open end of the base mold, the sides of the first portion of the insert will contact and slide upon the interior surface of the sidewall as the insert is pushed toward a lower or bottom end of the base mold situated upon the support surface, such as a cookie sheet.

Once an upper end or edge of the insert is substantially even or level with an upper edge of the sidewall of the base mold, translation of the insert into the interior cavity ceases, and the insert has been positioned in an inserted position. By forming the total length of the insert slightly smaller than a total length of the sidewall of the base mold, stopping the translation of the insert into the interior cavity when the upper edge of the base mold is substantially even or aligned with the upper edge of the sidewall, a first gap between the first end of the insert and the support surface of the cookie sheet is formed. The width or size of this first gap is determined by the total length of the insert from the first end to the upper edge. As such, for a cookie that is thicker at a lower surface under the formed cavity of the cookie, the total length is lessened, and for a thinner lower surface of a cookie, the total length of the insert is larger.

A second portion of the insert is configured with a circumferential or perimeter edge that is smaller than that of the first portion of the insert. This smaller configuration serves to form a second gap between the interior surface of the sidewall of the base mold, which surrounds the exterior of the second portion of the insert.

This second gap is in fluid communication with the first gap, with the insert located to the inserted position. Consequently, the liquid or pliable cookie or cake dough forms a circular U-shape wall where a cookie wall extends from a cookie base and surrounds and defines a cookie recess positioned within the formed cookie wall and above the cookie base. With the cookie mold in this position holding the dough in shape, the device may be inserted into an oven, whereupon the cookie dough is baked and forms a baked good in a permanent cup shape and configuration.

The mold herein is especially well adapted for use in a grouping or forming a grid thereof upon a cookie sheet or the like to yield multiple similarly-configured baked goods with each having substantially the same dimensions and shape. Using such a plurality of the base molds which may be coupled to each other in a spaced configuration, each base mold is positionable upon the support surface, such as a cookie sheet, with the other base molds of the plurality positioned adjacently or in close proximity thereto to form a grouping of molds. The molds in this grid configuration may be coupled to each other to form air space around each base mold to allow for even cooking when in an oven.

With the grouping of molds so formed, the uncooked dough portions may be deposited onto the cookie sheet or within each interior cavity of each base mold, so long as at the lower end of each base mold, there is a portion of dough. Thereafter, a respective individual insert may be positioned into the upper open end of each base mold. With a plurality of inserts, where one of each of the plurality is located into a respective interior cavity, a planar sheet may be employed to push each of the inserts into respective inserted positions within a respective interior cavity of a respective base mold. Alternatively, a grid of inserts may be formed in a unitary structure where the spacing of each of the inserts in the grid thereof aligns with the open ends of the base molds in a base mold grid situated upon a support surface, such as a cookie sheet or silicon baking sheet, or the like. Where the inserts are formed as a grid thereof coupled together they the grid may be engaged with or have a solid backing, thereby allowing insertion concurrently of one insert into each of the base molds in a base mold grid of coupled base molds.

Using the plurality of molds concurrently scales up the use of the device herein to allow formation of a plurality of similarly shaped cookies or cakes, or other baked goods, with one baked good each within each interior cavity into the inserted position. Thereafter, the grouping of molds located atop a mounting surface, such as a cookie sheet or the like, is inserted into an oven wherein each portion of dough is cooked to form a similarly shaped cookie or cake.

Upon cessation of baking, the cookies or cakes having recesses formed therein on a top surface may be easily removed from the base mold. Removal, depending upon the dough being employed and the type of baked good, may be accomplished by simply removing the insert and urging the formed baked good from the lower open end of the base mold with a finger or with an elongated member or some type of pushing tool. Removal of the baked good through the open lower end may also be accomplished by elevating the base mold above a surface and then pushing the insert toward the open end at the lower end of the base mold until both the baked good, such as a cookie, falls therefrom along with the insert. If the base molds are coupled to form a grid thereof, then removal members, which are aligned with each of the base molds in a base mold grid, are pushed into the upper or top open end of the base mold and through the open lower end. Such will cause all of the baked goods and inserts to fall from the lower open end onto a chosen surface.

The device herein may as noted also be provided in a singular configuration with one base mold and one insert for forming the cookie or baked good at the lower end of the base mold. The singular configuration functions the same for forming, baking, and removing the baked good through the lower open end of the base mold, and allows the user to buy a plurality of the devices herein sufficient for them to make baked goods for their intended purpose. For example, a home baker may only need a few of the devices, whereas a commercial baker may need hundreds and may want the base molds, inserts, and removal members to be employed concurrently for forming and removing the finished baked goods.

With respect to the above description, before explaining at least one preferred embodiment of the herein disclosed cookie and cake molding device and system in detail, it is to be understood that the invention is not limited in its application to the details of construction and to the arrangement of the components in the following description or as illustrated in the drawings. The cake and cookie molding device and system herein described and disclosed is capable of other embodiments and of being practiced and carried out in various equivalent ways, which will become obvious to those skilled in the art upon reading this disclosure. Also, it is to be understood that the phraseology and terminology employed herein are for the purpose of description and should not be regarded as limiting.

As such, those skilled in the art subsequent to reading this disclosure, will appreciate that the conception upon which this disclosure is based may readily be utilized as a basis for the designing of other cake and cookie molds and substantially equivalent structures, methods, and systems for carrying out the several purposes of the present disclosed device. It is important, therefore, that the claims be regarded as including such equivalent configurations, constructions, and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of.” Thus, the phrase “consisting of” indicates that the listed elements are required or mandatory, and no other elements may be present. By “consisting essentially of,” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially,” unless otherwise specifically defined, means plus or minus five percent.

It is an object of the present invention to provide a baking mold system employable for forming similarly shaped baked goods, such as small cakes and cookies, which provides for easy formation of baked goods having a uniform recess formed into the resulting cookie in a manner that saves time.

It is an additional object of this invention to provide such a baking mold device and system that allows for the formation of highly similar cakes and cookies with a plurality of molds positioned in a grouping or coupled grid on a baking sheet, all at the same time.

It is a further object of this invention to provide a two-piece baking mold device having a first component in the form of a base mold with an interior cavity communicating with two open ends and having an insert positionable in the interior cavity to form baked goods at a lower end thereof having a recess therein.

These and other objects, features, and advantages of the present baking mold device and system as well as the advantages thereof over existing prior art, which will become apparent from the description to follow, are accomplished by the improvements described in this specification and hereinafter described in the following detailed description which fully discloses the cake and cookie and baked goods mold device and system but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed cake and cookie mold and system and configurations herein. It is intended that the embodiments and figures disclosed herein are to be considered illustrative of the invention herein, rather than limiting in any fashion.

### In the Drawings:

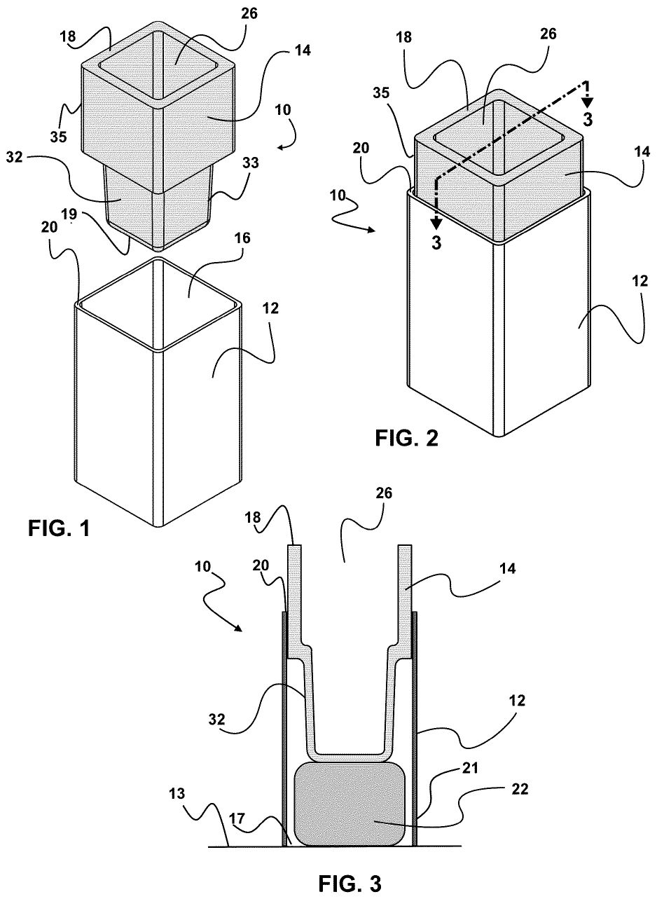

FIG. 1 shows an exploded view of the base mold and the insert of the device herein, where the insert is positioned for insertion into the upper open end and into an interior cavity of the base mold.

FIG. 2 shows the insert positioned within the interior cavity of the base mold with the upper end or edge of the insert located above the upper end of the base mold.

FIG. 3 is a sectional view along line 3-3 of FIG. 2 showing the dough to be formed and cooked to form the baked good positioned at a bottom end of the interior cavity of the base mold with the insert positioned at the upper end of the interior cavity of the base mold.

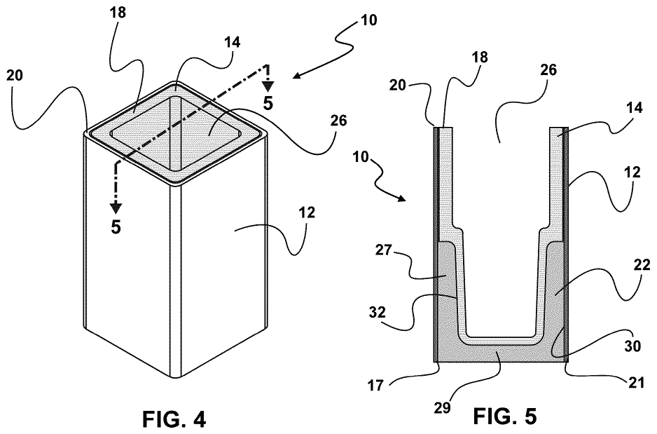

FIG. 4 shows the insert translated to an inserted position within the interior cavity of the base mold, with the upper end or edge of the insert substantially even or aligned with the upper end of the sidewall of the base mold, which provides the user with optically viewable alignment to discern that the insert is properly positioned with the base mold.

FIG. 5 is a sectional view along line 5-5 of FIG. 4 showing the insert in the inserted position within the interior cavity, forming a cup-like portion of the internal cavity, whereupon dough inserted into the interior cavity is formed to a cup-like shape within the formed baking cavity.

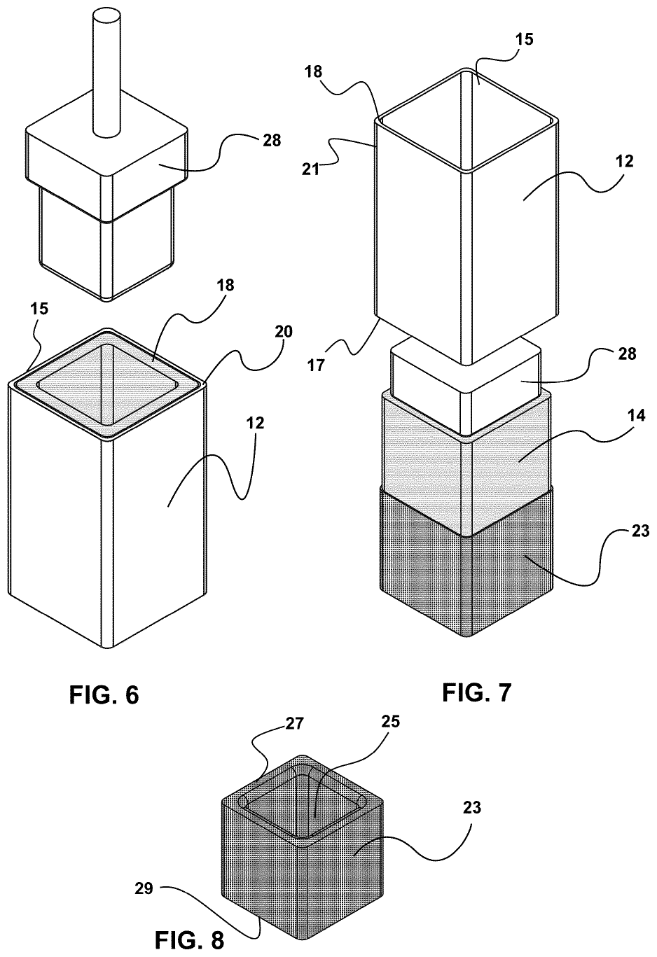

FIG. 6 shows the removal member positioned for insertion into the interior cavity of the insert to remove the insert.

FIG. 7 depicts the removal of the insert and cooked baked good using a removal member or the like to push both the insert and cooked baked good from an open lower end of the base mold.

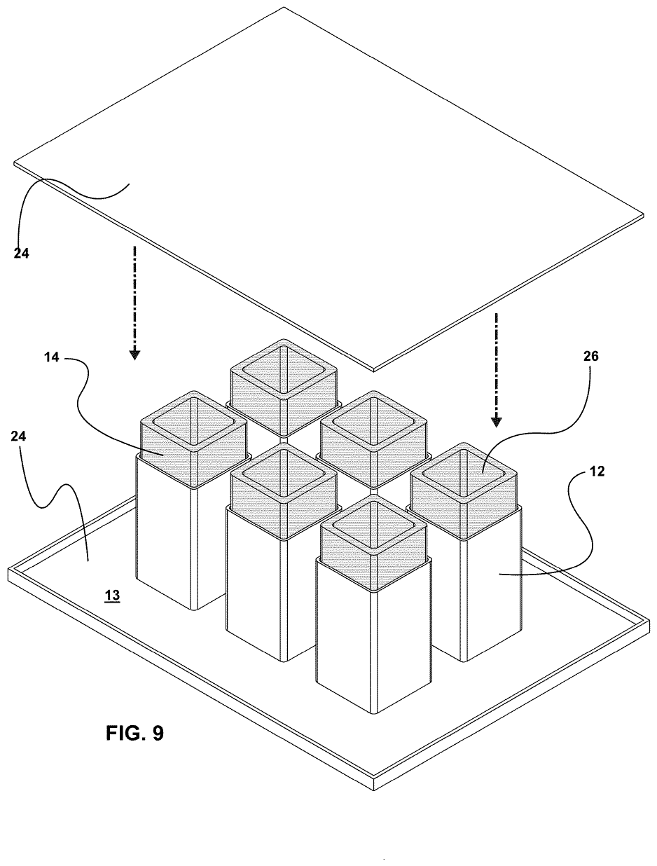

FIG. 8 shows the formed baked good, such as a cookie or cake, using the mold device and system herein, wherein a recess is formed into an upper surface thereof.

FIG. 9 depicts the formation of a grouping of molds which may be coupled together, wherein the insert for each base mold has been positioned at the upper end of the interior cavity and can be translated to the inserted position by a planar sheet, such as a cookie sheet.

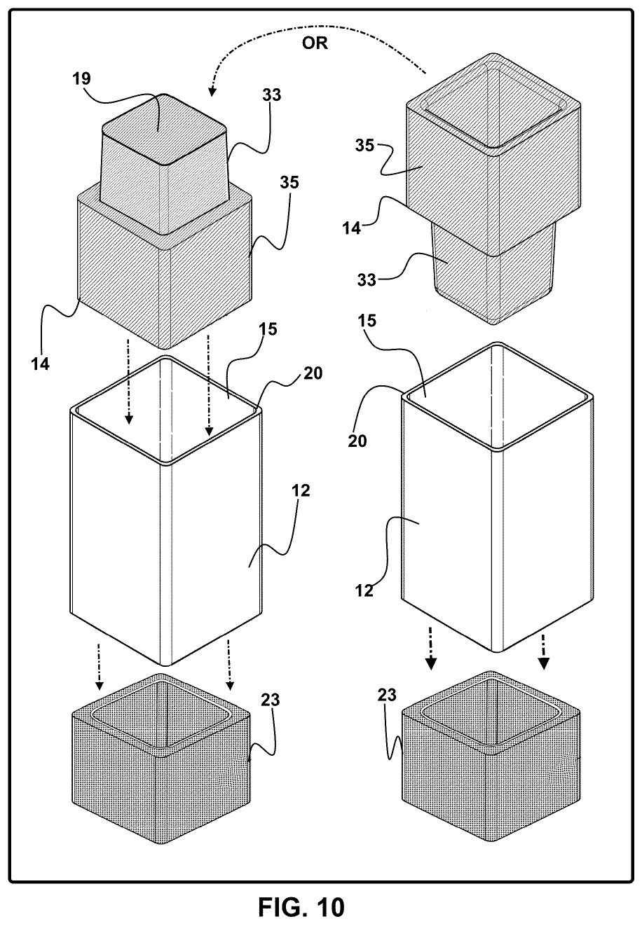

FIG. 10 shows other ways the baked good may be removed, such as removing the insert and pushing the baked good through the lower open end, or flipping a removed insert around and pushing the larger end toward the open lower end of the base mold.

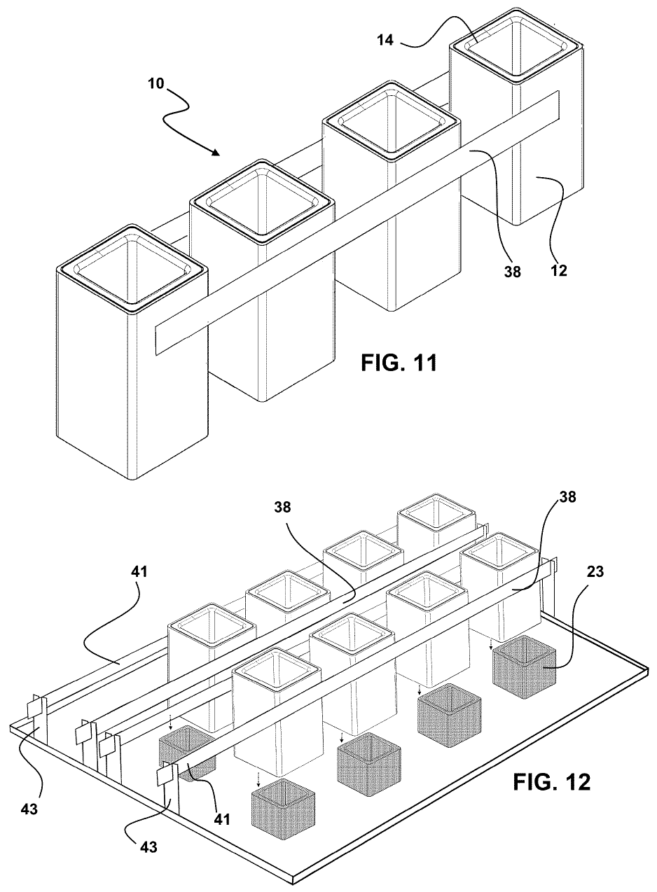

FIG. 11 depicts a plurality of base molds coupled together to allow for concurrent use to form baked goods using inserts.

FIG. 12 shows an example of the base molds herein formed to a grid, where coupled base molds may be coupled to supports to hold the base molds elevated after baking to allow for removal of the baked good through a lower open end of the base molds.

### DETAILED DESCRIPTION OF THE INVENTION

In this description, the directional prepositions of up, upwardly, down, downwardly, front, back, top, upper, bottom, lower, left, right, first, second, and other such terms refer to the configuration of the mold device and system for baking cakes and cookies and the like herein as it is oriented and appears in the drawings and all such terms are used for convenience only and such are not intended to be limiting or to imply that the disclosed device has to be used or positioned in any particular orientation.

Now referring to drawings in FIGS. 1-12, wherein similar components are identified by like reference numerals, there is seen in FIG. 1 an exploded view of the shaped formation components of the device 10. As shown, a base mold 12 has a first opening 15 communicating with an interior cavity 16 sized for the positioning of an insert 14 therein into the interior cavity 16 of the base mold 12. The batter 22 to form the baked good 23 may be pre-positioned at the lower end of the interior cavity 16 within a second open end 17 and upon a support surface 13 for the device 10. As can be discerned, the dough 22 or batter will take on the desired cup-shape of the portion of the interior cavity 16 with a recessed area 25 on an upper side of the baked good 23 surrounded by a baked good sidewall 27 and situated above a baked good bottom wall 29. This shape and the thickness of the baked good sidewall 27 and baked good lower wall 29 are determined by the shape and circumference of the second end portion 33.

Where the circumference of the second end portion 33 is larger and thereby closer to the side of the baked good sidewall 27 will be thinner, and where the circumference is made smaller, the baked good sidewall 27 will be thicker. Further, where the insert length of the insert 14 from the insert upper end 18 to the end surface 19 on the second end portion 33 is shorter. When the insert 14 is even with the upper end 18 is even with the base mold upper surface 20, the lower surface 29 of the baked good will be thicker. Where the insert length is longer, when the insert 14 is even with the upper end 18 is even with the base mold upper surface 20, the lower surface 29 of the baked good will be thinner.

Shown in FIGS. 2-8 and 10 and 13 is the operation of the device 10 herein. In FIG. 2, the components of FIG. 1 are shown, as with all configurations of the device 10, with the insert 14 positioned at the upper end of the interior cavity 16 of the base mold 12. The insert 14 is slid into the interior cavity 16 until an upper edge 18 of the insert is positioned substantially level or even with the upper end 20 of the base mold 12, which surrounds it. As shown in FIG. 4, this level or even positioning provides a visual cue for the user that the insert 14 is positioned properly within the upper end of the interior cavity 16 of the base mold 12, when the insert upper end 18 substantially aligns with the base mold upper end 20 and when the batter 22 has been positioned on the support surface 13 at the second open end 17 communicating with the interior cavity 16 as in FIG. 5.

As can be seen, the length of the insert 14 from the first end, which, as shown, is the upper end 18 to an end surface 19 of the second end portion 33 positioned opposite the upper end 18, is less than a base mold length from the base mold upper end 20 to the opposite base mold lower end 21. The length of the insert 14 may vary in this regard to vary a thickness of the baked good bottom 29 situated adjacent to or below the recessed area 25 of the baked good 23.

Shown in FIG. 3 is a sectional view of the base mold 12 with the insert 14 operatively engaged along line 3-3 of FIG. 2. As shown, the batter 22 is pre-positioned on a support surface 13 at the lower end of the interior cavity 16 at the second open end 17.

In FIG. 4, the components of FIG. 1 are shown with the insert 14 translated to a proper inserted position within the interior cavity 16 of the base mold 12. An upper edge 18 of the insert is depicted substantially even or level with the upper end 20 of the base mold 12 which surrounds it. By substantially level or even is meant plus or minus one-half the distance between the end surface 19 and the support surface 13, with the insert translated to the inserted position. This level or even positioning, as noted, provides a visual cue that the insert 14 is positioned properly within the interior cavity 16 so as to provide a mold surface in combination with the interior cavity and the support surface 13, such as a cookie sheet 24 (FIG. 9) for the batter 22. The batter 22, once baked within these confines, will form a baked good 23, such as a cup-shaped cookie or the like, or any other combination of the shape of the second end portion of the insert 14 and the size of the surrounding interior cavity 16. In all modes of the device 10, the cooked baked good 23 may be removed easily through the second open end 17 of the base mold 12.

While shown rectangular in shape, the second end portion 33 may be round or triangular, or any other shape required for forming a recessed area 25 into the baked good 23 of the same shape and size. Preferably, the second end portion 33 tapers from a wider end adjacent the first end portion 35 to a narrower circumference at the end surface 19 of the insert 14. The taper has been shown to allow for easier disconnection of the second end portion 33 from the baked good sidewall 27 and the baked good lower wall 29 of the formed recessed area 25 of the baked good 23.

Shown in FIG. 5 is a sectional view of the base mold 12 with the insert 14 operatively engaged or in the inserted position, along line 5-5 of FIG. 4. As shown, a cup-like portion of the interior cavity 16 is formed between the exterior surface 32 of the front portion 33 of the insert 14 and the interior wall of the interior cavity 16 and the support surface 13 (FIG. 3). The batter 22 positioned as in FIG. 3 will be compressed with the insert 14 in the inserted position of FIGS. 4-5 to form a cup-like shape during baking. A stepped second end portion 33 of the insert 14, as noted, provides an area in which the batter 22 resides while insert 14 of the device 10 is in the inserted configuration and is placed in the oven for baking. Thus, a cup like baked good mold shape is formed by the combination of the support surface 13, such as a cookie sheet 24 on which the base mold 12 and batter 22 are positioned, and the interior wall 30 of the interior cavity and the exterior surface 32 of the second end portion 33 of the insert 14 in the engaged position of FIG. 4.

Additionally shown in FIGS. 1-5 is a recess 26 formed into the first end of the insert 14. While not required for operation of the device 10 herein, this recess 26 may be configured to engage with an engagement end of a removal member 28, such as in FIG. 6. This removal member 28 is employable to impart force to slide the insert 14 into the first end of the base mold 12 and out of the second end of the base mold 12, once the batter 22 is baked. Where the device 10 is employed with coupled grids of molds as in FIGS. 12-13, the removal members will also be engaged in a matching grid and the shape of the removal members 28 will be complementary to the shape of the recess 26 if provided. If no recess 26 is included then simply a member to press on the first end of the insert 14 may provide the needed force.

The removal member 28, as shown in FIG. 6 and FIG. 7, may be engaged with the first end of the insert 14. Once baking is finished. Once operatively engaged, the removal member 28 may be used to push the insert 14 out of the second open end 17 at the second end of the base mold 12. Also, pushed from the base mold 12 by the force of the removal member 28 is the baked good 23. As shown, the baked good mold shape has yielded a baked good 23 in a cup-like shape. In some cases, the insert 14 may only need to be pushed toward the second open end 17, and the baked good 23 will fall out.

Shown in FIG. 9 is the device 10 of FIGS. 1-8, but in a plurality or grid formation atop the support surface 13, such as a cookie sheet 24 or the like, in an upscaled use of the device 10 and system. In this mode, the batter 22 may be pre-positioned at the lower end of each interior cavity 16 with an insert 14 therein positioned to be translated into the inserted position, in each respective base mold 12 in a group of adjacent base molds 12. The pushing of a plurality of inserts 14 into the plurality of interior cavities 16 may be done individually, or using a pushing surface to push all at once, such as a cookie sheet or formed specialty tool component for such. Once baking is done, the inserts 14 are removed in the above-noted manner along with the formed baked good 23.

FIG. 10 depicts other ways the baked goods 23 may be ejected from the interior cavity 16 at the second open end 17 of the base mold 12. As shown the insert 14 may simply be removed and the bake good 23 pushed from the second open end 17 with a finger to tool. Alternatively, the insert 14 may be removed and flipped upside down, and the upper end thereof may be pushed through the first open end 15 and far enough through the interior cavity 16 to cause the ejection of the baked good 23 through the second open end 17.

As noted above FIGS. 11 and 12 show the employment of the device 10 in grids or pluralities of base molds 12 with inserts wherein each base mold 12 is coupled and spaced from adjacent base molds 12 by a coupling member 38 such as by welding a metal coupling member 38 to the base molds 12. other ways the baked good may be removed such as removing the insert and pushing the bake good through the lower open end, or flipping a removed insert around and pushing the larger end toward the open lower end of the base mold. Thus as in FIG. 12, a plurality of base molds 12 coupled together to allow for concurrent use to form baked goods using inserts 14 in each base mold 12.

As an example in a commercial setting, the coupled grids of base molds 12 may include connectors 41 to hold the coupled base molds 12 elevated on supports 43 once baking has finished. The supports 43 may even be powered to slide upward above the support surface 13 to raise the base molds 12 with inserts 14 operatively coupled therein to an elevated position such as in FIG. 12. Once so elevated a grid of removal members 28 in alignment with the grid of assembled devices 10 of base molds 12 with inserts 14 may be employed to push the inserts 14 toward the second open end 17 of the base molds 12 to dismount the baked goods 23. Alternative removal might also be by vibration.

As noted, any of the different configurations and components of the mold for baking and method of employment thereof, shown and described herein, can be employed with any other configuration or component shown and described as part of the system herein.

Additionally, while the disclosed invention has been described herein with reference to particular embodiments thereof and components thereof operatively engaged for operation, a latitude of equivalent modifications, various changes and substitutions are intended in the foregoing disclosures and it will be appreciated that in some instance some features, or configurations, or operations of the invention could be employed without a corresponding use of other features without departing from the scope of the invention as set forth in the following claims. All such changes, alternations and modifications as would occur to those skilled in the art subsequent to reviewing this specification, are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract included herein is neither intended to define the invention of the application, which is measured by the claims, nor is it intended to be limiting, as to the scope of the invention in any way.

What is claimed is:

1. A mold for formation of cup-shaped baked goods, comprising:
a base mold having an interior cavity defined by an interior surface of a sidewall, said sidewall extending between a first open end at a first end of said base mold and a second open end at a second end of said base mold;
said base mold positionable to a supported position upon a support surface for surrounding dough during a baking thereof;
an insert, said insert extending between a first edge thereof and an end surface at a second end of said insert;
a first end portion of said insert extending between said first edge of said insert and a second end of said first end portion, said first end portion having an exterior surface which slidably engages against said interior surface of said sidewall;
a second end portion of said insert extending from said second end of said first end portion to said end surface;
said insert positionable to an inserted position at said first end of said base mold having said exterior surface of said first end portion engaged against said interior surface of said sidewall;
an end portion area of said interior cavity having a cup-like shape, said end portion area defined by an exterior surface of said second end, said interior surface of said sidewall, said end surface, and said support surface with said base mold in said inserted position and said base mold in said supported position; and
whereby said dough assumes said cup like shape during said baking thereof.
wherein dough positioned within said cup-like portion of said interior cavity assumes a cup-like shape during

2. The mold for formation of cup-shaped baked goods of claim 1, additionally comprising:
said insert in said inserted position having said first edge thereof substantially level with an end of said sidewall at said first end of said base portion, defining a visual cue to a user that the insert is positioned properly to said inserted position within the interior cavity.

4. The mold for formation of cup-shaped baked goods of claim 1, additionally comprising:
a removal member, said removal member positionable upon said first edge of said insert to force said insert through said second open end.

5. The mold for formation of cup-shaped baked goods of claim 2, additionally comprising:
a removal member, said removal member positionable upon said first edge of said insert to force said insert through said second open end.

6. The mold for formation of cup-shaped baked goods of claim 4, additionally comprising:
said first edge of said insert surrounding a recess; and
said removal member configured for removable coupling within said recess.

7. The mold for formation of cup-shaped baked goods of claim 5, additionally comprising:
said first edge of said insert surrounding a recess; and
said removal member configured for removable coupling within said recess.

8. The mold for formation of cup-shaped baked goods of claim 1, additionally comprising:
a plurality of said base molds coupled together to form a grid;
each of said base molds in said grid having respective inserts insertable therein, whereby a plurality of pieces of dough are formed to said cup-like shape for baking.

9. The mold for formation of cup-shaped baked goods of claim 2, additionally comprising:
a plurality of said base molds coupled together to form a grid;
each of said base molds in said grid having respective inserts insertable therein, whereby a plurality of pieces of dough are formed to said cup-like shape for baking.

10. The mold for formation of cup-shaped baked goods of claim 5, additionally comprising:
a plurality of said base molds coupled together to form a grid;
each of said base molds in said grid having respective inserts insertable therein, whereby a plurality of pieces of dough are formed to said cup-like shape for baking; and
a plurality of said removable members coupled for positioning a respective one thereof upon a respective said first edge of a respective one of said inserts.

11. The mold for formation of cup-shaped baked goods of claim 7, additionally comprising
a said first edge of each of said inserts surrounding a said recess; and
a plurality of said removable members coupled for positioning of a respective one thereof upon a respective said first edge of a respective one of said inserts.

12. The mold for formation of cup-shaped baked goods of claim 1, additionally comprising:
said second end portion of said insert tapering from a wider portion thereof at said second end of said first end portion to a narrower portion thereof at said end surface.

13. The mold for formation of cup-shaped baked goods of claim 2, additionally comprising:
said second end portion of said insert tapering from a wider portion thereof at said second end of said first end portion to a narrower portion thereof at said end surface.

14. The mold for formation of cup-shaped baked goods of claim 3, additionally comprising:
said second end portion of said insert tapering from a wider portion thereof at said second end of said first end portion to a narrower portion thereof at said end surface.

15. A mold for formation of cup-shaped baked goods from dough positioned therein, comprising:
a base mold having an interior cavity defined by an interior surface of a sidewall, said sidewall extending between a first open end at a first end of said base mold and a second open end at a second end of said base mold;
said base mold for positioning to a supported position upon a support surface surrounding said dough during a baking thereof;
an insert, said insert having a body formed of pliable material, said insert extending between a first edge thereof to an end surface thereof, at a second end of said insert;
said insert positionable to an inserted position through said first open end;
a first end portion of said insert extending between said first edge of said insert and a second end of said first end portion;
an exterior surface of said first end portion forming a sealed slidable coupling against said interior surface of said sidewall with said insert in said inserted position;
a second end portion of said insert extending from said second end of said first end portion, to said end surface;
an end portion area of said interior cavity having a cup-like shape with said insert in said inserted position and said base mold in said supported position; and
whereby said dough within said end portion assumes said cup-like shape during said baking thereof.

16. The mold for formation of cup-shaped baked goods of claim 15, additionally comprising:
said second end portion of said insert tapering from a wider portion thereof at said second end of said first end portion to a narrower portion thereof at said end surface.
